(19) United States
(12) Patent Application Publication
(10) Pub. No.: US 2025/0023232 A1
(43) Pub. Date: Jan. 16, 2025

(54) OPTICAL BEAMFORMING PROCESSOR WITH A DIFFERENTIALLY SEGMENTED APERTURE ANTENNA

(71) Applicant: Battelle Memorial Institute, Columbus, OH (US)

(72) Inventors: Jonathan A. GLUCK, Columbus, OH (US); Richard J. HIGGINS, Lewis Center, OH (US)

(21) Appl. No.: 18/770,788

(22) Filed: Jul. 12, 2024

Related U.S. Application Data
(60) Provisional application No. 63/513,183, filed on Jul. 12, 2023.
(60) Provisional application No. 63/584,186, filed on Sep. 21, 2023.

(51) Int. Cl. H01Q 3/26

(52) U.S. Cl. CPC H01Q 3/2676

(57) ABSTRACT

In an approach to steering and beam shaping RF signals, an apparatus includes one or more radio frequency (RF) inputs, a differential segmented array (DSA) antenna, and a photonic true time delay engine. The photonic true time delay engine is configured to receive an input signal on each of the one or more RF inputs, adjust a respective amplitude and a time delay of each input signal, and feed each adjusted input signal to the DSA.

### CROSS-REFERENCE TO RELATED APPLICATIONS

The present application claims the benefit of the filing date of U.S. Provisional Application Ser. No. 63/513,183, filed Jul. 12, 2023, and U.S. Provisional Application Ser. No. 63/584,186, filed Sep. 21, 2023, the entire teachings of which applications are hereby incorporated herein by reference.

### TECHNICAL FIELD

The present disclosure relates to optical beam steering for a differential segmented array (DSA) antenna.

### BACKGROUND

Beamforming is the application of multiple radiating elements transmitting the same signal at the same wavelength and phase, which effectively creates a single antenna with a longer, more targeted stream. Beam steering takes the concept of beam forming a stage further, by changing the phase of the input signal on all radiating elements. This allows the signal to be targeted at a specific receiver. An antenna can employ radiating elements with a common frequency to steer a single beam in a specific direction, or different frequency beams can be steered in different directions to serve different users.

### BRIEF DESCRIPTION OF THE DRAWINGS

Reference should be made to the following detailed description which should be read in conjunction with the following figures, wherein like numerals represent like parts.

FIG. 1 is an example of a DSA consistent with the present disclosure.

FIG. 2 depicts an example block diagram of an apparatus and system for photonic wideband simultaneous beamforming consistent with the present disclosure.

FIG. 3 is an example of an illustrative embodiment of a photonic true time delay line with an optical microcomb source consistent with the present disclosure.

FIG. 4 is an example of another illustrative embodiment of a photonic true time delay line with an optical microcomb source consistent with the present disclosure.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

Wideband simultaneous beamforming has applications ranging from sixth generation (6G) mobile systems and Low Probability of Detection/Intercept (LPD/LPI) communications to advanced radar and remote sensing techniques. Phase shifting or digital signal manipulation techniques are typically used for beam steering with phased array antennas. Phased arrays require control of phase and amplitude per-carrier, per-beam, and per-element, quickly compounding the complexity or constraining the flexibility of an antenna aperture. Traditional antenna feed structures operate within a narrow bandwidth and limit the number simultaneous beams. Digital true time delay at an aperture scale remains costly and inefficient. Although these techniques work well with single or narrow-band signals, broadcasting multiple wideband channels simultaneously requires costly and power hungry digital processing or results in poor quality radiation patterns. There exists a need for wideband simultaneous beamforming that can overcome these limitations.

The limitations described above arise from the need for precise true time delays and amplitude weighting to steer a wideband beam. Opportunity exists to use the physics of free-space or fiber-guided optics to create the appropriate time delays. The upconversion of radio frequency (RF) signals to light enables the use of compact optics to form the necessary delay and amplitude shifts for a multitude of wideband beams to be emitted from a single aperture. Upon conversion back to RF, each pixel is fed with the appropriately delayed replicas of each source in the RF scene plane.

The DSA is an innovative ultra-wideband technology using non-resonant elements that function with sub-half-wavelength spacing-enabling more compact, multi-band, multi-antenna devices increasing spectral efficiency. The wideband and arrayed nature of the DSA makes it an ideal candidate for simultaneous, multi-carrier, wideband beamforming.

Photonic technology has been proposed as an alternative to digital signal manipulation techniques, but challenges exist in the development of a wideband aperture. Disclosed herein is an apparatus for steering and beam shaping RF signals comprising a photonic true time delay engine and a DSA. Beam steering and shaping is achieved by adjusting the respective amplitude and time delay of each feed signal into the DSA. The optical true time delay provides the appropriate phase delay to the segmented antenna elements regardless of bandwidth. The switching network allows for multiple signals to be radiated in different directions.

The disclosed apparatus and system provides appropriate phase shifts to all antenna segments for optimal beam steering regardless of bandwidth. No other non-digital beamforming method can utilize the wideband performance of the DSA. Existing digital processing will continue to demand high power computation, whereas the optical signal steering disclosed herein is much more efficient.

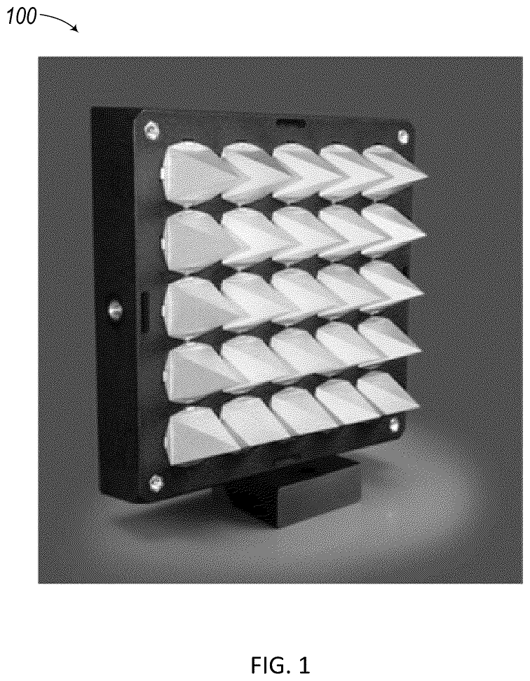

FIG. 1 is an example of a DSA 100 consistent with the present disclosure. The DSA 100 is a phased array of aperture segments that is used to steer the beam of a propagating electromagnetic wave, either transmitted or received, in a specific direction. This will focus the energy of the wave in the direction of interest. Likewise, it can be used to reject an interfering or jamming signal propagating from a specific direction by steering that signal into a null. The same methods used for beam steering can be employed to determine the azimuth of a signal of interest (SOI) that is received by the DSA 100. This concept combines the capability of the DSA 100 with existing and new phased array algorithms that can be implemented in, for example, a software defined radio.

The DSA 100 provides the following capabilities. First is beam steering, which maximizes received signal power of a signal of interest (SOI) originating from an azimuth off boresight (i.e., straight ahead). Second, is anti-jam capability, which significantly reduces the received signal power of a jamming signal without significant reduction of the SOI. Each of the three applications utilize the manipulation of phase angles between the segments in the DSA 100. Manipulation of these phase angles allows signals that are transmitted from or received by the individual segments to interfere constructively (maximizing power) or destructively (minimizing power) in a given direction to satisfy the objective.

The beam steering capabilities of the DSA 100 allow for wideband simultaneous beamforming as described earlier.

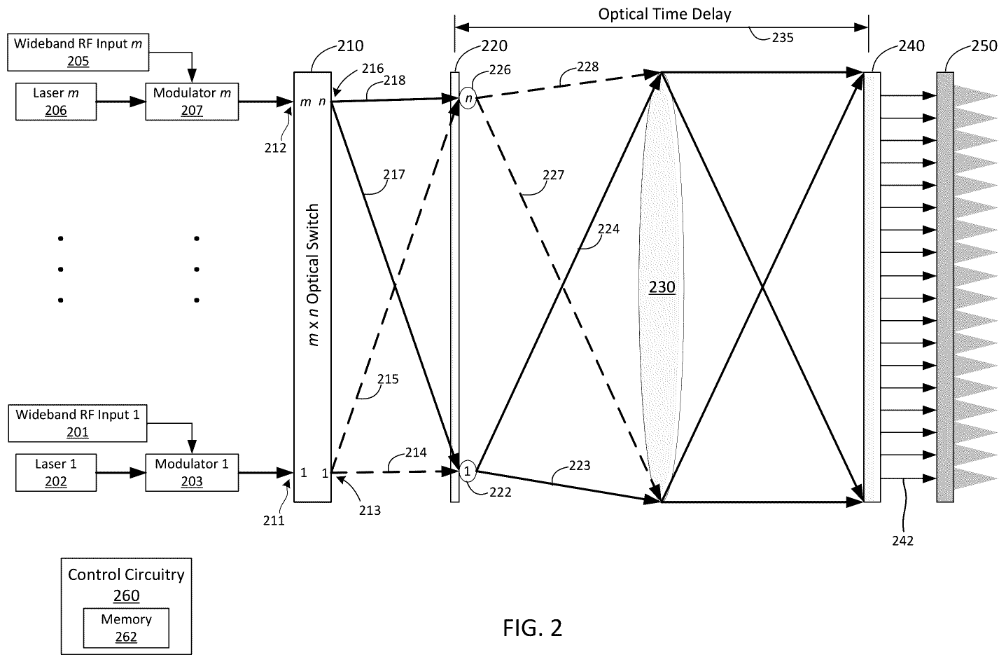

FIG. 2 depicts an illustrative example block diagram of an apparatus and system for photonic wideband simultaneous beamforming consistent with the present disclosure. It should be noted that although the illustrative example of FIG. 2 shows one possible embodiment of the optical beam steering for a DSA antenna, many modifications and variations are possible. Here, the output of a laser is modulated by an RF signal, and the modulated laser output drives an intensity modulated optical point source. The output of the intensity modulated optical point source is focused by a lens onto a detector array. The detector array drives the DSA.

In the illustrative example of FIG. 2, m lasers, laser-1 202 through laser-m 206, are each modulated by RF input signals, RF input-1 201 through RF input-m 205. The modulation is performed by modulator-1 203 through modulator-m 207, the outputs of which are fed as inputs into an optical switch 210. The optical switch selects which fixed position fiber will receive modulated light. Several technologies may be used to implement the optical switch, including micro-electromechanical system (MEMS), spatial light modulator, or Liquid Crystal Display (LCD). In this example, optical switch 210 has m inputs, switch input-1 211 through switch input-m 212, corresponding to the m modulated inputs signals, and n outputs, switch output-1 213 through switch output-n 216. Optical switch 210 may direct the output of each of modulator-1 203 through modulator-m 207 to any of the optical point sources, point source-1 222 through point source-n 226, located along the RF scene plane 220. For example, switch output-1 213 may be configured to direct its output to point source-1 222 via light path 214, to point source-n 226 via light path 215, or to any of the other light points along RF scene plane 220. Likewise, switch output-n 216 may be configured to direct its output to point source-1 222 via light path 217, to point source-n 226 via light path 218, or to any of the other light points along RF scene plane 220. The light from the optical point sources is spread over the lens to illuminate the detector array with the delay between the source and each detector determined by the location of the source. Each of the optical point sources, point source-1 222 through point source-n 226, may project an output onto lens 230. The lens 230 may be comprised of, for example, a single lens, a lens array, a diffractive optic, or combinations thereof. The optical point source-1 222 through point source-n 226 may be, for example, an optical fiber terminated with a lens to spread the emitted light to illuminate lens 230.

For example, point source-1 222 may project its output onto lens 230 based on the modulation of the signal driving the point source-1 222. Delay path 223 from point source-1 222 represents a shorter time delay than delay path 224 to lens 230. Similarly, delay path 227 from point source-n 226 represents a longer time delay than delay path 228 to lens 230. These delays will propagate through lens 230 to DSA 250.

The modulated signals from point source-1 222 through point source-n 226 are focused by lens 230 onto detector array 240. In some embodiments, detector array 240 may be comprised of an array of photodiodes. The detector array 240 performs the optical to electrical energy conversion to drive the DSA via adjusted input signals 242. The time delay of each modulated signal from modulator-1 203 through modulator-m 207 is based on the specific path from RF scene plane 220 through detector array 240. The time delay generated by the path is illustrated in FIG. 2 as optical time delay 235.

FIG. 2 may also contain control circuitry 260. Control circuitry 260 may be used, for example, to control optical switch 210 to direct the output of each of modulator-1 203 through modulator-m 207 to any of the optical point sources, point source-1 222 through point source-n 226, located along the RF scene plane 220.

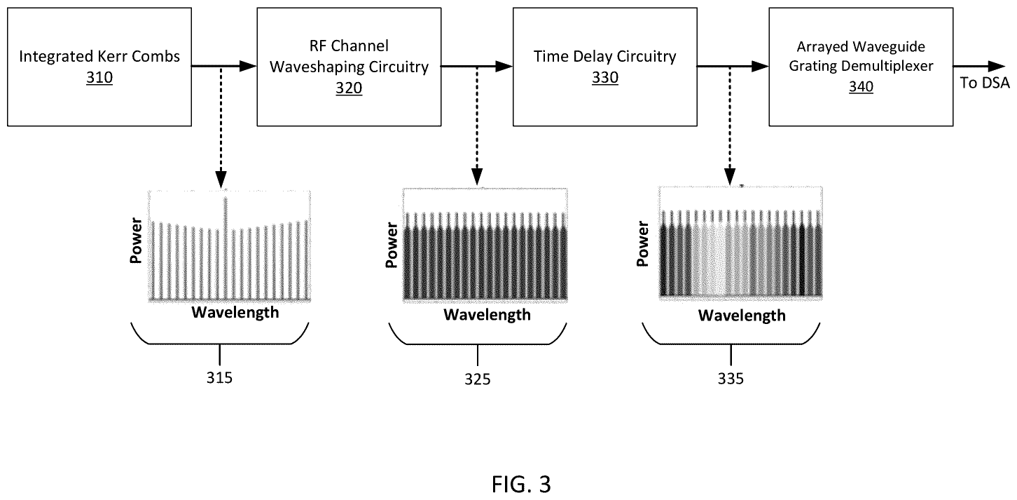

FIG. 3 is an example of a photonic true time delay line with an optical microcomb source consistent with the present disclosure. One of the important applications of an RF photonic true time delay line is in phased array antenna systems, where optical signals on selected channels are separately converted into the electrical domain and then fed to an antenna array to form radiating elements. The apparatus and system disclosed herein applies this concept to the DSA.

In the example of FIG. 3, the true time delay line is constructed with three modules. The first module, integrated Kerr combs 310, generates an optical microcomb with a large number of wavelength channels using a microresonator. In some embodiments, the integrated Kerr combs 310 may include a pump laser which drives a microring resonator to generate the microcomb. Optical frequency combs are specialized lasers that act like a ruler for light. They measure exact frequencies of light—from the invisible infrared and ultraviolet to visible red, yellow, green, and blue light—quickly and accurately. Optical frequency combs are used to measure and control light waves as if they were radio waves. Kerr frequency combs are optical frequency combs which are generated from a continuous wave pump laser by the Kerr nonlinearity. This coherent conversion of the pump laser to a frequency comb takes place inside an optical resonator which is typically micrometer to millimeter in size and is therefore termed a microresonator. Because Kerr frequency combs only rely on the nonlinear properties of the medium inside the microresonator and do not require a broadband laser gain medium, broad Kerr frequency combs can in principle be generated around any pump frequency. An example of the output microcomb is shown in FIG. 3 as graph-1 315.

The second module, RF channel waveshaping circuitry 320, shapes the optical microcomb and may direct it to a modulator, where replicas of the input RF signal are generated on each wavelength to establish multiple RF channels. In some embodiments, the RF channel waveshaping circuitry 320 may include a waveshaper which feeds its output into a modulator, for example, a Mach-Zehnder modulator. An example of the output of the RF channel waveshaping circuitry 320 is shown in graph-2 325.

Time delays are then introduced between the RF channels by dispersive elements in the third module, time delay circuitry 330. In this module, the time delays are fixed by wavelength, and one wavelength is selected per pixel. An example of the output of the time delay circuitry 330 is shown in graph-3 335.

A fourth module, arrayed waveguide grating 340 may be used as a demultiplexer, to split up the time dispersed wavelengths. The arrayed waveguide grating 340 is typically followed by an m×n optical switching network to route specific wavelengths to designated photodetectors, as described above in FIG. 2, to drive the DSA.

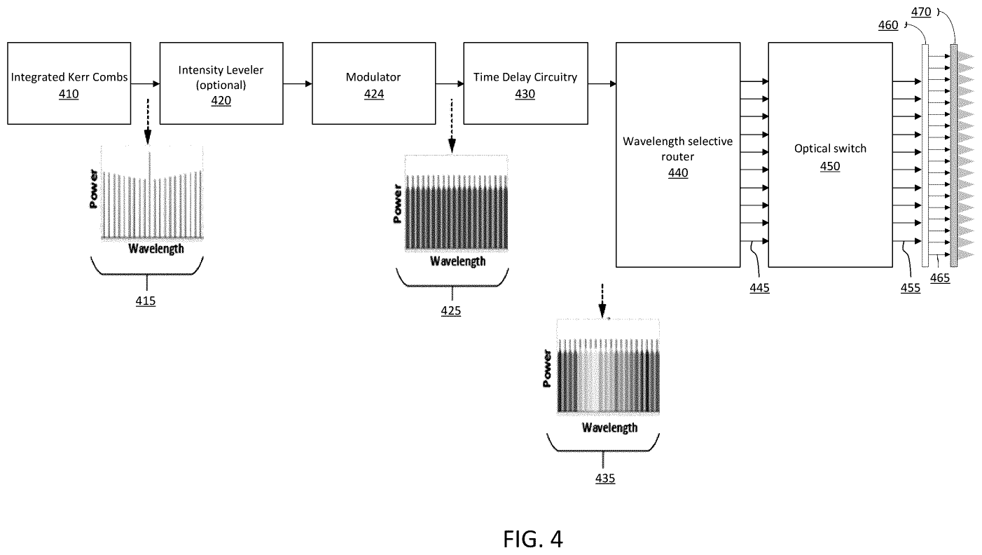

FIG. 4 is an example of another illustrative embodiment of a photonic true time delay line with an optical microcomb source consistent with the present disclosure. In the embodiment of FIG. 4, the true time delay line is constructed with four modules. The first module, integrated Kerr combs 410, generates an optical microcomb with a large number of wavelength channels using a microresonator, i.e., a microring resonator. In some embodiments, the integrated Kerr combs 410 may include a pump laser which drives the microring resonator to generate the microcomb. Optical frequency combs are specialized lasers that act like a ruler for light. The optical frequency comb generates a series of discrete, equally spaced, and ultra stable frequency lines. This is significant because the time-delay is based on the channel wavelength and any frequency jitter may adversely affect the steering efficiency. Kerr frequency combs are optical frequency combs which are generated from a continuous wave pump laser by the Kerr nonlinearity. This coherent conversion of the pump laser to a frequency comb takes place inside an optical resonator which is typically micrometer to millimeter in size and is therefore termed a microresonator. Because Kerr frequency combs only rely on the nonlinear properties of the medium inside the microresonator and do not require a broadband laser gain medium, broad Kerr frequency combs can in principle be generated around any pump frequency. An example of the output microcomb is shown in FIG. 4 as graph-1 415. The output of the integrated Kerr combs 410 may be fed into a modulator 424. The modulator 424 may be, for example, a Mach-Zehnder modulator. An example of the output of the modulator 424 is shown in graph-2 425.

In some embodiments, the output of the integrated Kerr combs 410 may optionally be fed into an intensity leveler 420 rather than directly into the modulator 424. The optional intensity leveler 420 may be used to level the gain for a range of frequencies generated by the integrated Kerr combs 410.

Time delays are then introduced between the RF channels of the outputs of the modulator by dispersive elements in the third module, time delay circuitry 430. In this module, the time delays are fixed by wavelength, and one wavelength is selected per pixel. One example of the time delay circuitry may be a wavelength dispersive fiber. An example of the output of the time delay circuitry 430 is shown in graph-3 435.

The fourth module may be a wavelength selective router 440 used as a demultiplexer, to split up the time dispersed wavelengths. Some examples of circuitry that may be used for the wavelength selective router 440 may include, but are not limited to, an arrayed waveguide grating (AWG), which may be a device that typically consists of an array of curved-channel waveguides with a fixed difference in the length of optical path between the adjacent channels, a fiber grating, which may be an optical element that divides (disperses) light composed of many different wavelengths (e.g., white light) into light components by wavelength, or a grating filter, which may be an optical filter with thin-film grating layers.

The wavelength selective router 440 sends the time dispersed wavelengths 445 to an optical switch 450 to route specific wavelengths to designated photodetectors. Several technologies may be used to implement the optical switch 450, including micro-electromechanical system (MEMS), spatial light modulator, or Liquid Crystal Display (LCD).

The modulated signals 455 from the optical switch 450 are projected onto detector array 460. In some embodiments, detector array 460 may be comprised of an array of photodiodes. The detector array 460 performs the optical to electrical conversion to drive the DSA 470 via DSA input signals 465. Each modulated signal from will have time delays based on the specific path from the modulator 424 through the detector array 460.

According to one aspect of the disclosure there is thus provided an apparatus for steering and beam shaping RF signals. The apparatus includes one or more radio frequency (RF) inputs, a differential segmented array (DSA) antenna, and a photonic true time delay engine. The photonic true time delay engine is configured to receive an input signal on each of the one or more RF inputs, adjust a respective amplitude and a time delay of each input signal, and feed each adjusted input signal to the DSA.

According to another aspect of the disclosure, there is thus provided a system for optical beam steering. The system includes one or more radio frequency (RF) inputs, one or more modulators, one or more optical point sources arranged in an RF scene plane, an optical switch, a detector array, a lens, and a differential segmented array (DSA) antenna. The system is configured to receive an input signal on each of the one or more RF inputs, convert the input signal on each of the one or more RF inputs to light, direct a modulator output of each of the one or more modulators to any optical point source using the optical switch to select the optical point source, direct a point source output of each of the one or more optical point sources to the detector array using the lens, convert the light from the lens to electrical energy using the detector array, and transmit a wave from the DSA antenna based on the one or more RF inputs, wherein each RF input of the one or more RF inputs is transmitted in a specific direction based on a time delay to focus energy of the wave in a direction of interest.

According to yet another aspect of the disclosure, there is thus provided a system for optical beam steering. The system includes one or more radio frequency (RF) inputs, one or more microresonators, one or more modulators, a wavelength selective router, an optical switch, a detector array, and a differential segmented array (DSA) antenna. The system is configured to receive an input signal on each of the one or more RF inputs, convert the input signal on each of the one or more RF inputs to one or more light inputs, generate a microcomb with a plurality of wavelength channels from each light input using the one or more microresonators, modulate the microcomb generated by the one or more microresonators using the one or more modulators, introduce a time delay to each wavelength channel of the plurality of wavelength channels, demultiplex the plurality of wavelength channels into a plurality of time dispersed wavelengths using the wavelength selective router, route the plurality of time dispersed wavelengths by specific wavelengths to a plurality of designated photodetectors on the detector array using the optical switch, convert the plurality of time dispersed wavelengths from the optical switch to electrical energy using the detector array, and transmit a wave from the DSA antenna based on the one or more RF inputs, wherein each RF input of the one or more RF inputs is transmitted in a specific direction based on the time delay to focus energy of the wave in a direction of interest.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

“Circuitry”, as used in any embodiment herein, may comprise, for example, singly or in any combination, hardwired circuitry, programmable circuitry such as one or more computer processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

Embodiments of the methods described herein may be implemented using a controller, processor, and/or other programmable device or circuitry, for example, control circuitry 260. To that end, the methods described herein may be implemented on a tangible, non-transitory computer readable medium having instructions stored thereon that when executed by one or more processors perform the methods. Thus, for example, the memory 262 may store instructions (in, for example, firmware or software) to perform the operations described herein. The storage medium, e.g. the memory 262, may include any type of tangible medium, for example, any type of disk optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

The functions of the various elements shown in the figures, including any functional blocks labeled as a controller or processor, may be provided through the use of dedicated hardware as well as hardware capable of executing software in association with appropriate software. The functions may be provided by a single dedicated processor, by a single shared processor, or by a plurality of individual processors, some of which may be shared. Moreover, explicit use of the term controller or processor should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

What is claimed is:

1. An apparatus for steering and beam shaping RF signals, the apparatus comprising:
one or more radio frequency (RF) inputs;
a differential segmented array (DSA) antenna; and
a photonic true time delay engine, wherein the photonic true time delay engine is configured to:
receive an input signal on each of the one or more RF inputs;
adjust a respective amplitude and a time delay of each input signal; and
feed each adjusted input signal to the DSA.

2. The apparatus of claim 1, wherein the photonic true time delay engine comprises:
one or more lasers;
one or more modulators;
an optical switch;
one or more optical point sources arranged in an RF scene plane;
a lens; and
a detector array.

3. The apparatus of claim 2, wherein the one or more modulators are configured to:
convert the input signal on each of the one or more RF inputs to light, each of the one or more modulators using one of the one or more lasers.

4. The apparatus of claim 3, wherein the optical switch is configured to:
direct a modulator output of each of the one or more modulators to a specific optical point source.

5. The apparatus of claim 3, wherein the lens is configured to:
direct a point source output of each of the one or more optical point sources to the detector array, wherein each point source output of each of the one or more optical point sources has a time delay based on a specific path from the RF scene plane through the lens to the detector array.

6. The apparatus of claim 5, wherein the detector array is configured to:
convert the point source output of each of the one or more optical point sources from the lens to electrical energy; and
send the electrical energy to the DSA antenna, causing the DSA antenna to transmit a wave based on the one or more RF inputs, wherein each RF input of the one or more RF inputs is transmitted in a specific direction based on the time delay to focus energy of the wave in a direction of interest.

7. The apparatus of claim 3, wherein the optical switch comprises a different number of optical inputs than optical outputs.

8. A system for optical beam steering, the system comprising:
one or more radio frequency (RF) inputs;
one or more modulators;
one or more optical point sources arranged in an RF scene plane;
an optical switch;
a detector array;
a lens; and
a differential segmented array (DSA) antenna, the system configured to:
receive an input signal on each of the one or more RF inputs;
convert the input signal on each of the one or more RF inputs to light;
direct a modulator output of each of the one or more modulators to any optical point source using the optical switch to select the optical point source;
direct a point source output of each of the one or more optical point sources to the detector array using the lens;
convert the light from the lens to electrical energy using the detector array; and
transmit a wave from the DSA antenna based on the one or more RF inputs, wherein each RF input of the one or more RF inputs is transmitted in a specific direction based on a time delay to focus energy of the wave in a direction of interest.

9. The system of claim 8, wherein the input signal on each of the one or more RF inputs is modulated by a specific modulator of the one or more modulators.

10. The system of claim 9 further comprising one or more lasers, wherein each of the one or more modulators uses a specific laser of the one or more lasers.

11. The system of claim 8, wherein the point source output of each of the one or more optical point sources has the time delay based on a specific path from the RF scene plane through the lens to the detector array.

12. A system for optical beam steering, the system comprising:
one or more radio frequency (RF) inputs;
one or more microresonators;
one or more modulators;
a wavelength selective router;
an optical switch;
a detector array; and
a differential segmented array (DSA) antenna, the system configured to:
receive an input signal on each of the one or more RF inputs;
convert the input signal on each of the one or more RF inputs to one or more light inputs;
generate a microcomb with a plurality of wavelength channels from each light input using the one or more microresonators;
modulate the microcomb generated by the one or more microresonators using the one or more modulators;
introduce a time delay to each wavelength channel of the plurality of wavelength channels;
demultiplex the plurality of wavelength channels into a plurality of time dispersed wavelengths using the wavelength selective router;
route the plurality of time dispersed wavelengths by specific wavelengths to a plurality of designated photodetectors on the detector array using the optical switch;
convert the plurality of time dispersed wavelengths from the optical switch to electrical energy using the detector array; and
transmit a wave from the DSA antenna based on the one or more RF inputs, wherein each RF input of the one or more RF inputs is transmitted in a specific direction based on the time delay to focus energy of the wave in a direction of interest.

13. The system of claim 12, wherein the one or more microresonators are one or more microring resonators.

14. The system of claim 12, wherein the one or more RF inputs are converted to the one or more light inputs by a laser.

15. The system of claim 12, wherein introduce the time delay to each wavelength channel of the plurality of wavelength channels further comprises:
each of the plurality of wavelength channels having a specific time delay.

16. The system of claim 13, wherein generate the microcomb with the plurality of wavelength channels from each of the one or more light inputs using the one or more microring resonators further comprises:
level a gain for a range of frequencies generated by the microcomb using an intensity leveler.

17. The system of claim 12, wherein the wavelength selective router is selected from a group consisting of an arrayed waveguide grating, a fiber grating, and a grating filter.

18. The system of claim 13, wherein the one or more microring resonators are one or more Kerr combs.

19. The system of claim 18, wherein the one or more Kerr combs further comprises one or more pump lasers.

20. The system of claim 12, wherein each of the one or more modulators is a Mach-Zehnder modulator.
